(19) United States
(12) Patent Application Publication
(10) Pub. No.: US 2004/0134421 A1
(43) Pub. Date: Jul. 15, 2004

(54) Apparatus and method for applying chemicals to substrates via the use of nonaqueous solvents

(76) Inventor: Larry Rising, Kernsville, NC (US)

Correspondence Address: CARY TOPE-MCKAY, TOPE-MCKAY & ASSOCIATES, 23852 PACIFIC COAST HIGHWAY #311, MALIBU, CA, 90265, US

(21) Appl. No.: 10/613,735

(22) Filed: Jul. 3, 2003

Related U.S. Application Data
(60) Provisional application No. 60/394,212, filed on Jul. 3, 2002.

(51) Int. Cl. B05C 11/00; B05D 5/00

(52) U.S. Cl. 118/61; 118/56; 118/50; 427/271

(57) ABSTRACT

The present invention comprises a machine and method for applying chemicals with substrates in a continuous manner, as opposed to batch processes. The machine uses non-aqueous solvents as a carrier medium for the chemicals. The non-aqueous solvents are then evaporated away, leaving the chemicals on the substrates. Additionally, the non-aqueous solvents are then continuously condensed, purified and recycled through the machine.

### PRIORITY CLAIM

This application claims the benefit of priority to provisional application No. 60/394,212, filed in the United States on Jul. 3, 2002, and titled “Water repelling and recycling device”.

### FIELD OF INVENTION

The present invention relates to an apparatus and method for applying chemicals to substrates through a continuous process, and more specifically, to a machine using non-aqueous solvents as a carrier medium for the chemicals, with the non-aqueous solvents being evaporated away and leaving the chemicals on the substrates, and with the non-aqueous solvents thereafter continuously condensed, purified and recycled through the machine while the process runs.

### BACKGROUND OF INVENTION

It is often desirable that substrates, such as textiles, be treated to enhance certain properties, such as fire or water resistance. This is often accomplished through an addition of chemicals to the substrates in order to impart the desired properties.

Historically, the addition of chemicals to substrates has been accomplished through aqueous-based systems, requiring large amounts of energy and expensive drying systems. Traditionally, chemicals have been applied to substrates using a batch method wherein substrates are discontinuously run through a machine. The substrates are introduced into the machine, and the machine is shut down after the completion of each batch in order to remove and dry the treated substrates and to insert new substrates into the machine.

The traditional batch method does not effectively recycle solvents; the machine is frequently shut down in order reclaim any solvent. The solvent is then sent off to a recovery site while new or recovered solvent is added into the machine. The inefficient recycling of solvents results in chemical exhaust and waste, creating special environmental problems and requiring regulation by the Environmental Protection Agency.

Therefore, there exists a need for an apparatus that applies chemicals to substrates through a continuous process, using non-aqueous and environmentally friendly solvents, thereby reducing costs and improving quality of treated substrates.

The apparatus in the present invention fulfills this need in two aspects. First, the present invention provides a process whereby substrates can be continuously fed into and removed from the apparatus without having to stop the process. Second, the apparatus actually purifies any contaminated solvent and continuously reintroduces any reclaimed solvent back to the process.

### SUMMARY OF INVENTION

The apparatus of the present invention comprises a machine for applying chemicals to substrates via the use of non-aqueous solvents. The machine has an application chamber portion containing an application apparatus. The application apparatus is adapted to introduce a chemical mixture into contact with a substrate, forming a wet substrate. The chemical mixture is comprised of a non-aqueous solvent and a chemical solute. A removal portion is connected with the application portion, wherein the non-aqueous solvent is removed from the wet substrate, leaving a substrate with remaining chemical solution.

In another aspect, the application apparatus is an item selected from a group consisting of a foam applicator, spray applicator, and a padding applicator.

In addition, the removal portion comprises a removal apparatus for removing a portion of the chemical mixture from the wet substrate, leaving a substrate with remaining chemical mixture; a vacuum chamber in fluid communication with the removal apparatus for lowering a boiling point of the non-aqueous solvent in the substrate with remaining chemical mixture; and an evaporator apparatus connected with the vacuum chamber to evaporate the non-aqueous solvent into a solvent vapor.

In addition, the removal apparatus may be a squeeze roller; the evaporator apparatus may be a heat exchanger; and the heat exchanger may be a steam-based heat exchanger.

In another aspect, a blower apparatus is in fluid communication with the machine, creating a negative pressure and thereby preventing vapors from escaping. Additionally, a separator is connected with the blower apparatus to remove remaining solvent vapors.

In addition, the blower apparatus is an item selected from a group consisting of a fan, and a blower.

In yet another aspect, the separator comprises a mist eliminator and a high efficiency separator, further removing solvent vapors.

In another aspect of the present invention, the machine has a collector portion for collecting any removed non-aqueous solvent.

In another aspect, the collector portion comprises a vapor scrubber chamber, where the solvent vapor is pushed into the vapor scrubber chamber via a negative pressure difference between the vapor scrubber chamber and surrounding areas; a condensing apparatus associated with the vapor scrubber chamber, condensing the solvent vapor into a condensed liquid solvent solution; a re-boiler tank in fluid communication with the vapor scrubber chamber and the removal apparatus, the re-boiler tank collecting the condensed liquid solvent solution and the portion of the chemical mixture into a collected solution, where the collected solution is heated to vaporize the non-aqueous solvent into a re-vaporized non-aqueous solvent; a cooling chamber connected with the re-boiler tank, where the re-vaporized non-aqueous solvent is condensed into a re-condensed non-aqueous solvent; and a recovery tank associated with the cooling chamber to collect the re-condensed non-aqueous solvent.

Furthermore, the condensing apparatus may be a water spray mechanism; and the re-boiler tank may be heated through a steam-based heat exchanger.

Furthermore, the re-condensed non-aqueous solvent may be pumped from the recovery tank to a mix tank, where it may be combined with appropriate chemicals to create the chemical mixture, or pumped directly to the application apparatus.

Additionally, the chemical mixture may be optionally pumped to an additional application apparatus, where it is applied to an additional side of the substrate.

In another aspect, the present invention comprises a method for applying a chemical solution to a substrate. The method comprises the acts of forming a chemical mixture comprising a non-aqueous solvent and a chemical solute; applying the chemical mixture with the substrate, forming a wet substrate; and removing the non-aqueous solvent from the wet substrate, leaving substrate with remaining chemical solution.

In yet another aspect, the method for applying a chemical solution to a substrate further comprises an act of selecting an application apparatus before the act of applying the chemical mixture to the substrate, the application apparatus being selected from a group consisting of a foam applicator, spray applicator, and a padding applicator.

In another aspect, the act of removing the non-aqueous solvent from the wet substrate comprises acts of removing a portion of the chemical mixture from the wet substrate, leaving a substrate with remaining chemical mixture; lowering a boiling point of the non-aqueous solvent in the substrate with remaining chemical mixture; and evaporating the non-aqueous solvent into a solvent vapor.

In addition, the method for applying a chemical solution to a substrate further comprises an act of using a squeeze roller as a removal apparatus, before the act of removing a portion of the chemical mixture from the wet substrate.

Furthermore, the method for applying a chemical solution to a substrate further comprises an act of using a heat exchanger as an evaporator apparatus, before the act of evaporating the non-aqueous solvent into a solvent vapor.

Additionally, the method for applying a chemical solution to a substrate further comprises an act of using a steam-based heat exchanger as the heat exchanger.

In another aspect, the method for applying a chemical solution to a substrate, further comprises an act of preventing vapors from escaping by creating a negative pressure; and removing remaining solvent vapors.

In addition, the method for applying a chemical solution to a substrate further comprises an act of selecting a blower apparatus before the act of preventing vapors from escaping by creating a negative pressure. The blower apparatus is selected from a group consisting of a fan, and a blower.

In yet another aspect, the method for applying a chemical solution to a substrate further comprises an act of using a separator comprising a mist eliminator and a high efficiency separator, before the act of removing remaining solvent vapors.

In another aspect, the method for applying a chemical solution to a substrate, further comprises an act of collecting any removed non-aqueous solvent.

In yet another aspect, the act of collecting any removed non-aqueous solvent comprises acts of pushing the solvent vapor into a vapor scrubber chamber via a negative pressure difference between the vapor scrubber chamber and surrounding areas; condensing the solvent vapor into a condensed liquid solvent solution; collecting the condensed liquid solvent solution and the portion of the chemical mixture into a collected solution; heating the collected solution to vaporize the non-aqueous solvent into a re-vaporized non-aqueous solvent; cooling and condensing the re-vaporized non-aqueous solvent into a re-condensed non-aqueous solvent; and collecting the re-condensed non-aqueous solvent.

In yet another aspect, method for applying a chemical solution to a substrate further comprises an act of using a water spray mechanism as a condensing apparatus, before the act of condensing the solvent vapor into a condensed liquid solvent solution.

In another aspect, the method for applying a chemical solution to a substrate further comprises an act of using a steam-based heat exchanger as the method for heating a re-boiler tank, before the act of heating the collected solution to vaporize the non-aqueous solvent into a re-vaporized non-aqueous solvent.

Additionally, the method for applying a chemical solution to a substrate further comprises an act of pumping the re-condensed non-aqueous solvent from the recovery tank to a mix tank, where it may be combined with appropriate chemicals to create the chemical mixture.

In addition, the method for applying a chemical solution to a substrate further comprises an act of pumping the chemical mixture to the application apparatus, and optionally, to the additional application apparatus.

In another aspect of the present invention, the present invention comprises a machine for applying a chemical solution to a substrate. The machine comprises a means for forming a chemical mixture comprising a non-aqueous solvent and a chemical solute; a means for applying the chemical mixture with the substrate, forming a wet substrate; and a means for removing the non-aqueous solvent from the wet substrate, leaving substrate with remaining chemical solution.

Additionally, the means for applying the chemical mixture with the substrate, forming a wet substrate, is an item selected from a group consisting of a foam applicator, spray applicator, and a padding applicator.

In addition, the means for removing the non-aqueous solvent from the wet substrate comprises a means for removing a portion of the chemical mixture from the wet substrate, leaving a substrate with remaining chemical mixture; a means for lowering a boiling point of the non-aqueous solvent in the substrate with remaining chemical mixture; and a means for evaporating the non-aqueous solvent into a solvent vapor.

In addition, the means for removing a portion of the chemical mixture from the wet substrate may be a squeeze roller; the evaporating means is a heat exchanger; and the heat exchanger is a steam-based heat exchanger.

In yet another aspect, the machine for applying a chemical solution to a substrate further comprises a means for preventing vapors from escaping by creating a negative pressure; and a means for removing remaining solvent vapors.

In another aspect, the means for preventing vapors from escaping by creating a negative pressure, is an item selected from a group consisting of a fan, and a blower.

Additionally, the means for removing remaining solvent vapors, is a mist eliminator and a high efficiency separator.

In another aspect, the machine for applying a chemical solution to a substrate further comprises a means for collecting any removed non-aqueous solvent.

Furthermore, the means for collecting any removed non-aqueous solvent comprises a means for pushing the solvent vapor into a vapor scrubber chamber via a negative pressure difference between the vapor scrubber chamber and surrounding areas; a means for condensing the solvent vapor into a condensed liquid solvent solution; a means for collecting the condensed liquid solvent solution and the portion of the chemical mixture into a collected solution; a means for heating the collected solution to vaporize the non-aqueous solvent into a re-vaporized non-aqueous solvent; a means for cooling and condensing the re-vaporized non-aqueous solvent into a re-condensed non-aqueous solvent; and a means for collecting the re-condensed non-aqueous solvent.

Furthermore, the condensing means is a water spray mechanism; and the means for heating the collected solution to vaporize the non-aqueous solvent into a re-vaporized non-aqueous solvent, is a steam-based heat exchanger.

Furthermore, the machine for applying a chemical solution to a substrate further comprises a means for pumping the re-condensed non-aqueous solvent from the recovery tank to a mix tank. Once in the mix tank, it may be combined with appropriate chemicals to create the chemical mixture.

Further, the machine for applying a chemical solution to a substrate further comprises a means for pumping the chemical mixture to the application apparatus, and optionally, to an additional application apparatus.

Finally, the machine for applying a chemical solution to a substrate, further comprises a means for applying the chemical mixture to an additional side of the substrate.

### BRIEF DESCRIPTION OF THE DRAWINGS

The nature of the machine and the process described herein will be readily apparent in the following drawings, in which:

FIG. 1 is a side perspective view of a machine operating according to the present invention, cut away to illustrate the interior of the machine;

FIG. 2 is a side perspective view of a machine operating according to the present invention, cut away to illustrate the interior of the machine and to demonstrate the treatment of vapors and solvents; and

FIG. 3 is a flow chart, demonstrating acts performed by the present invention.

### DETAILED DESCRIPTION OF THE PREFERRED EMBODIMENTS

The present invention relates to an apparatus for applying chemicals to substrates, and more specifically, to a machine using non-aqueous solvents as a carrier medium for the chemicals, with the solvents being evaporated away and leaving the chemicals on the substrates. Further, the machine may apply the chemicals directly or indirectly to the substrates, with the solvents again being evaporated away and leaving the chemicals on the substrates. The following description, taken in conjunction with the referenced drawings, is presented to enable one of ordinary skill in the art to make and use the invention. Various modifications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

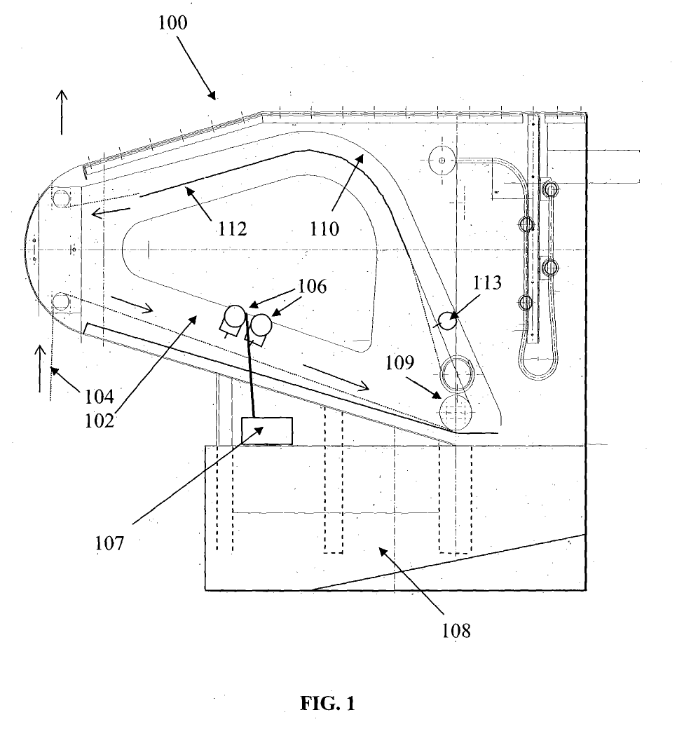

Referring to the figures, FIG. 1 illustrates an aspect of the machine 100 in accordance with the present invention. The machine 100 has an application chamber portion 102, where a substrate 104 is introduced with a chemical mixture via an application apparatus 106, forming a wet substrate. The substrate 104 is constructed of at least one layer of any suitable material, non-limiting examples of which include textile, non-woven textile, paper, and leather. The chemical mixture is comprised of a non-aqueous solvent and a chemical solute. The non-aqueous solvent is comprised of at least one suitable carrier medium. For example, the non-aqueous solvent may be comprised of n-propyl bromide. For a more thorough understanding of suitable carrier mediums, please see attached Appendix A. Attached hereto as Appendix A is non-provisional utility application, which outlines a chemical formulation using non-aqueous carrier mediums to apply fluorocarbons and other organic chemicals to textile substrates. Further, the chemical solution is comprised of at least one suitable solute, non-limiting examples of which include fluorocarbons, fire-retardants, anti-stats, anti-microbials, and UV inhibitors.

The chemical mixture may be separately formed and introduced to the application apparatus 106; mixed in a mix tank 107 and introduced to the application apparatus 106; or pumped directly from a recovery tank 108 to the application apparatus 106: The application apparatus 106 takes the form of any suitable apparatus for applying the chemical mixture with the substrate 104, non-limiting examples of which include a foam applicator, a spray applicator, and a padding applicator.

After introducing the chemical mixture with the substrate 104, the substrate 104 then interacts with a removal portion. The removal portion comprises a removal apparatus 109, a vacuum chamber 110, and an evaporator apparatus 112. Upon entering the removal portion, the substrate 104 interacts with the removal apparatus 109, where a portion of the chemical mixture is removed from the substrate 104. The removal apparatus 109 may be any suitable apparatus for removing excess chemical mixture from the substrate 104. For example, the removal apparatus 109 may be a squeeze roller. In this aspect, the substrate 104 passes through the squeeze roller where excess chemical mixture is squeezed from the substrate 104, leaving a substrate with remaining chemical mixture. After interacting with the removal apparatus 109, the substrate with remaining chemical mixture may optionally interact with an additional application apparatus 113, where the chemical mixture is applied to an additional side of the substrate 104.

After interacting with the removal apparatus 109, the substrate with remaining chemical mixture then enters a vacuum chamber 110, where negative pressure lowers a boiling point of the non-aqueous solvent. In the vacuum chamber 110, the substrate with remaining chemical mixture interacts with an evaporator apparatus 112. The evaporator apparatus 112 is used to evaporate the non-aqueous solvent into a solvent vapor, thereby removing the non-aqueous solvent from the substrate 104. The evaporator apparatus 112 may be any suitable apparatus for evaporating the non-aqueous solvent. For example, the evaporator apparatus 112 may be a heat exchanger. Further, the heat exchanger may be a steam-based heat exchanger, where steam is passed through the heat exchanger, providing a sufficient amount of heat to evaporate the non-aqueous solvent. After having come in contact with the evaporator apparatus 112, the substrate 104 then leaves the vacuum chamber 110 and subsequently leaves the machine 100 altogether, with the chemical solution remaining and the non-aqueous solvent removed.

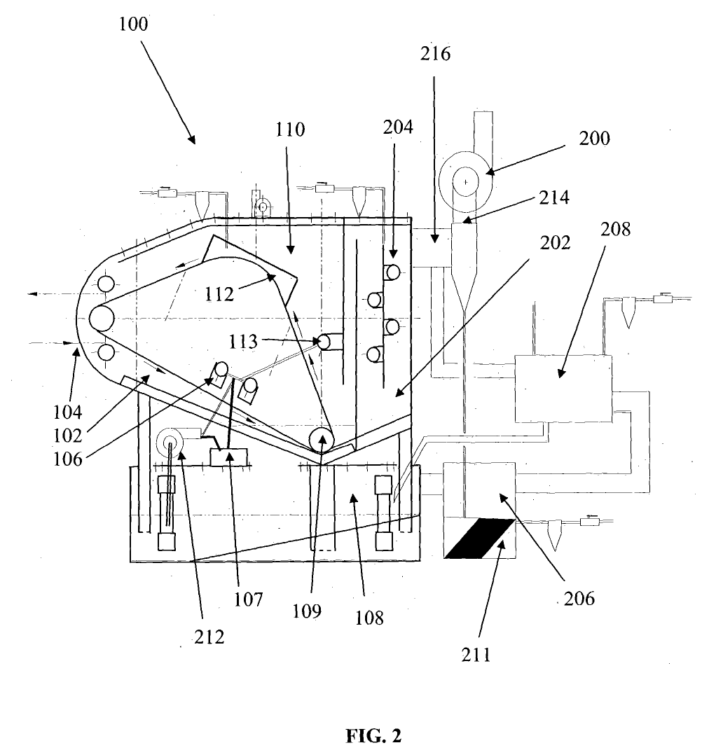

As illustrated in FIG. 2, a blower apparatus 200 is in fluid communication with the machine 100. The blower apparatus 200 may be any suitable apparatus for displacing air, non-limiting examples of which include a fan, and a blower. The blower apparatus 200 pushes the solvent vapor from the vacuum chamber 110 to a collector portion. The collector portion comprises a vapor scrubber chamber 202, a condensing apparatus 204, a re-boiler tank 206, a cooling chamber 208, and a recovery tank 108. The solvent vapors are pushed into the vapor scrubber chamber 202 via a negative pressure difference between the vapor scrubber chamber 202 and surrounding areas. Associated with the vapor scrubber chamber 202 is a condensing apparatus 204. The condensing apparatus 204 may be any suitable apparatus for condensing the solvent vapor into a condensed liquid solvent solution, a non-limiting example of which includes a water spray mechanism.

After condensing, the condensed liquid solvent solution then falls into a re-boiler tank 206. The re-boiler tank 206 also collects the portion of the chemical mixture removed from the substrate 104 by the removal apparatus 109, combining the two solutions into a collected solution 211. The collected solution 211 is heated to a temperature less than the boiling point of water, but greater than the boiling point of the non-aqueous solvent, thereby vaporizing the non-aqueous solvent into a re-vaporized non-aqueous solvent. The re-boiler tank 206 may be heated using any suitable means for heating such a tank, a non-limiting example of which includes a steam-based heat exchanger.

The re-vaporized non-aqueous solvent is then pushed via the blower apparatus 200 into a cooling chamber 208. Once in the cooling chamber 208, the re-vaporized non-aqueous solvent is condensed into a re-condensed non-aqueous solvent, and thereafter returns to the recovery tank 108. The cooling chamber 208 may use any suitable means for cooling and condensing a vapor, a non-limiting example of which includes using cooling pipes.

In the recovery tank 108, there is a small amount of water that condenses with the non-aqueous solvent. The small amount of water readily separates from the non-aqueous solvent due to differences in specific gravity and is decanted away and out of the machine 100. After decanting away the small amount of water, the re-condensed non-aqueous solvent is substantially pure and may be recycled through the machine 100. Through the use of a pump 212, the re-condensed non-aqueous solvent may be pumped from the recovery tank 108 to a mix tank 107, where it is combined with appropriate chemicals to create the chemical mixture. The chemical mixture may then be pumped to the application apparatus 106, and optionally to the additional application apparatus 113, where it is applied to a new substrate. Or in the alternative, the re-condensed non-aqueous solvent may be pumped directly from the recovery tank 108 to the application apparatus 106, and optionally to the additional application apparatus 113.

Additionally, the blower apparatus 200 creates a negative pressure, preventing vapors from escaping the machine 100. The negative pressure is defined as a decreasing difference in atmospheric pressure between an internal portion 214 of the blower apparatus 200 and further distanced chambers and areas of the machine 100, where there exists a high pressure at the further distanced chambers and areas of the machine 100, and where the blower apparatus 200 creates a low pressure at the internal portion 214 of the blower apparatus 200. The negative pressure therefore pushes concentrated solvent vapors from the vacuum chamber 110 and the re-boiler tank 206, and fugitive vapors from the application chamber portion 102, the vapor scrubber chamber 202, and the cooling chamber 208, towards the blower apparatus 200 and through a separator 216. The separator 216 comprises a mist eliminator and a high efficiency separator. The high efficiency separator is comprised as a component of the separator 216, further removing moisture molecules from air to a low-micron level, and ensuring that air leaving the system is substantially liquid free. Once in the separator 216, any remaining vapors are pushed through the mist eliminator and the high efficiency separator, such that any exhaust is air, with solvent vapors removed. Further, all moisture that collects on the mist eliminator is introduced into the separator 216, where water and the non-aqueous solvent readily separate. The non-aqueous solvent is then returned to the recovery tank 108, where any remaining water contamination is decanted away.

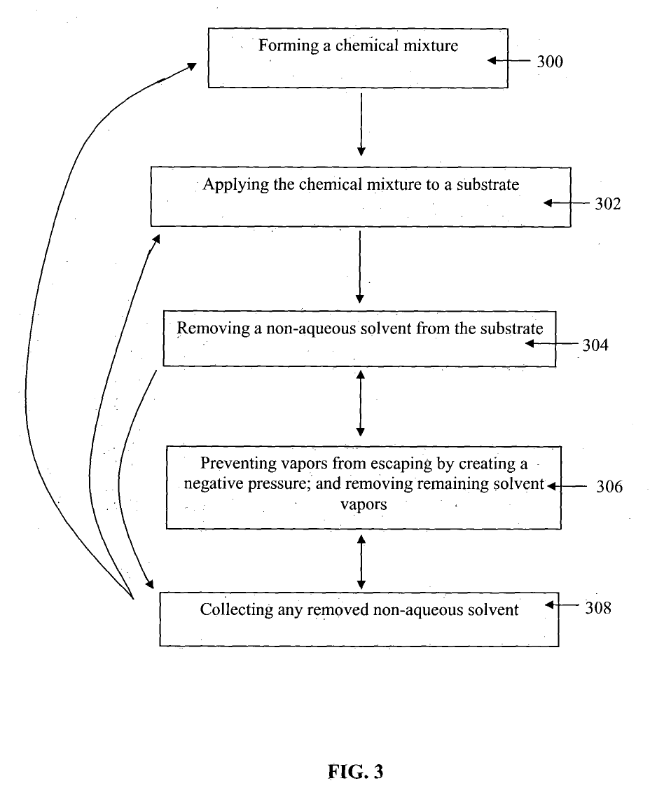

Illustrated in FIG. 3 are acts performed in applying a chemical solution to a substrate in the scope of the invention. The functions of the machine described above constitute a method, operations of which are described below.

The method comprises an act of forming a chemical mixture 300 comprising a non-aqueous solvent and a chemical solute. Non-limiting examples of which include mixing the non-aqueous solvent and chemical solution separately, and thereafter introducing the chemical mixture to an application apparatus 106; forming the chemical mixture in a mix tank 107 and thereafter introducing the chemical mixture 107 to the application apparatus 106; or pumping the chemical mixture directly from a recovery tank 108 to the application apparatus 106.

The method further comprises an act of applying the chemical mixture to the substrate 302, forming a wet substrate, a non-limiting example of which includes using an application apparatus 106. The application apparatus 106 is an item selected from a group consisting of a foam applicator, spray applicator, and a padding applicator. Additionally, the chemical mixture may be applied to an additional side of the substrate through use of an additional application apparatus 113.

Furthermore, the method comprises an act of removing the non-aqueous solvent from the wet substrate 304, leaving a substrate with remaining chemical solution. A non-limiting example of which comprises the acts of removing a portion of the chemical mixture from the wet substrate, leaving a substrate with remaining chemical mixture; lowering a boiling point of the non-aqueous solvent in the substrate with remaining chemical mixture; and evaporating the non-aqueous solvent into a solvent vapor.

The act of removing a portion of the chemical mixture from the substrate may be accomplished through use of a removal apparatus 109, a non-limiting example of which includes a squeeze roller. The act of lowering a boiling point of the non-aqueous solvent may be accomplished through use of a vacuum chamber 110, thereby decreasing the pressure and lowering the boiling point of the non-aqueous solvent. Furthermore, the act of evaporating the non-aqueous solvent into a solvent vapor may be accomplished. through use of an evaporator apparatus 112, a non-limiting example of which includes a heat-exchanger, or in another aspect, a steam-based heat exchanger.

In addition, the method comprises the acts of preventing vapors from escaping by creating a negative pressure; and removing remaining solvent vapors 306. The act of preventing vapors from escaping by creating a negative pressure may be achieved through the use of any suitable apparatus for displacing air, a non-limiting example of which includes a blower apparatus 200. For example, the blower apparatus 200 may take the form of a blower, or a fan. Additionally, the act of removing remaining solvent vapors may be accomplished through the use of a separator 216, a non-limiting example of which includes a separator 216 comprising a mist eliminator and high efficiency separator.

Furthermore, the method comprises an act of collecting any removed non-aqueous solvent 308. A non-limiting example of collecting any removed non-aqueous solvent 308, comprises acts of pushing the solvent vapor into a vapor scrubber chamber 202 via a negative pressure difference between the vapor scrubber chamber 202 and surrounding areas; condensing the solvent vapor into a condensed liquid solvent solution; collecting the condensed liquid solvent solution and the portion of the chemical mixture into a collected solution 211; heating the collected solution 211 to vaporize the non-aqueous solvent into a re-vaporized non-aqueous solvent; cooling and condensing the re-vaporized non-aqueous solvent into a re-condensed non-aqueous solvent; and collecting the re-condensed non-aqueous solvent.

The act of pushing the solvent vapor into vapor scrubber chamber 202 may be accomplished through use of a blower apparatus 200, non-limiting examples of which include a blower, or a fan. Additionally, the act of condensing the solvent vapor into a condensed liquid solvent solution may be achieved through use of a condensing apparatus 204, a non-limiting example of which includes a water spray mechanism. In addition, the act of collecting the condensed liquid solvent solution and the portion of the chemical mixture into a collected solution 211, and the act of heating the collected solution 211 to vaporize the non-aqueous solvent into a re-vaporized non-aqueous solvent, may be accomplished through use of a re-boiler tank 206. Furthermore, the act of cooling and condensing the re-vaporized non-aqueous solvent into a re-condensed non-aqueous solvent, may be achieved through use of a cooling chamber 208, a non-limiting example of which includes using cooling pipes.

Additionally, the act of collecting the re-condensed non-aqueous solvent may be accomplished through use of any suitable means for collecting a liquid solution, a non-limiting example of which includes use of a recovery tank 108. Once in the recovery tank 108, there is a small amount of water that condenses with the non-aqueous solvent. The small amount of water may be readily separated from the non-aqueous solvent due to differences in specific gravity and then further decanted away and out of the machine 100. After decanting away the small amount of water, the re-condensed non-aqueous solvent is substantially pure and may be recycled through the machine 100. Through the use of a pump 212, the re-condensed non-aqueous solvent may be pumped from the recovery tank 108 to a mix tank 107, where it is combined with appropriate chemicals to create the chemical mixture. The chemical mixture may then be pumped to the application apparatus 106, and optionally to the additional application apparatus 113, where it is applied to a new substrate. Or in the alternative, the re-condensed non-aqueous solvent may be pumped directly from the recovery tank 108 to the application apparatus 106, and optionally to the additional application apparatus 113.

What is claimed is:

1. A machine comprising:
an application chamber portion containing an application apparatus, the application apparatus is adapted to introduce a chemical mixture into contact with a substrate, wherein the chemical mixture comprises a non-aqueous solvent and a chemical solute, and wherein the substrate with the chemical mixture forms a wet substrate; and
a removal portion connected with the application portion wherein the non-aqueous solvent is removed from the wet substrate, leaving a substrate with remaining chemical solution.

2. A machine as set forth in claim 1, wherein the application apparatus is selected from a group consisting of a foam applicator, spray applicator, and a padding applicator.

3. A machine as set forth in claim 1, wherein:
the removal portion comprises a removal apparatus for removing a portion of the chemical mixture from the wet substrate, leaving a substrate with remaining chemical mixture;
a vacuum chamber in fluid communication with the removal apparatus for lowering a boiling point of the non-aqueous solvent in the substrate with remaining chemical mixture; and
an evaporator apparatus connected with the vacuum chamber to evaporate the non-aqueous solvent into a solvent vapor.

4. A machine as set forth in claim 3, wherein the removal apparatus is a squeeze roller.

5. A machine as set forth in claim 3, wherein the evaporator apparatus is a heat exchanger.

6. A machine as set forth in claim 5, wherein the heat exchanger is a steam-based heat exchanger.

7. A machine as set forth in claim 3, further comprising:
a blower apparatus in fluid communication with the machine, creating a negative pressure and thereby preventing vapors from escaping; and
a separator connected with the blower apparatus to remove remaining solvent vapors.

8. A machine as set forth in claim 7, wherein the blower apparatus comprises an item selected from a group consisting of a fan, and a blower.

9. A machine as set forth in claim 7, wherein the separator comprises a mist eliminator and a high efficiency separator, further removing solvent vapors.

10. A machine as set forth in claim 7, further comprising a collector portion for collecting removed non-aqueous solvent.

11. A machine as set forth in claim 10, wherein:
the collector portion comprises a vapor scrubber chamber, where solvent vapor is pushed into the vapor scrubber chamber via the negative pressure;
a condensing apparatus associated with the vapor scrubber chamber, condensing the solvent vapor into a condensed liquid solvent solution;
a re-boiler tank in fluid communication with the vapor scrubber chamber and the removal apparatus, the re-boiler tank collecting the condensed liquid solvent solution and the portion of the chemical mixture into a collected solution, where the collected solution is heated to vaporize the non-aqueous solvent into a re-vaporized non-aqueous solvent;
a cooling chamber connected with the re-boiler tank, where the re-vaporized non-aqueous solvent is condensed into a re-condensed non-aqueous solvent; and
a recovery tank associated with the cooling chamber to collect the re-condensed non-aqueous solvent.

12. A machine as set forth in claim 11, wherein the condensing apparatus is a water spray mechanism.

13. A machine as set forth in claim 11, wherein the re-boiler tank further comprises a steam-based heat exchanger.

14. A machine as set forth in claim 11, further comprising a mix tank, wherein the re-condensed non-aqueous solvent is pumped from the recovery tank to the mix tank, where it is combined with appropriate chemicals to create the chemical mixture.

15. A machine as set forth in claim 12, wherein the application apparatus is selected from a group consisting of a foam applicator, spray applicator, and a padding applicator.

16. A machine as set forth in claim 15, wherein the removal apparatus is a squeeze roller.

17. A machine as set forth in claim 16, wherein the evaporator apparatus is a heat exchanger.

18. A machine as set forth in claim 17, wherein the heat exchanger is a steam-based heat exchanger.

19. A machine as set forth in claim 18, wherein the blower apparatus comprises an item selected from a group consisting of a fan, and a blower.

20. A machine as set forth in claim 19, wherein the separator comprises a mist eliminator and a high efficiency separator, further removing solvent vapors.

21. A machine as set forth in claim 20, wherein the re-boiler tank further comprises a steam-based heat exchanger.

22. A machine as set forth in claim 21, further comprising a mix tank, wherein the re-condensed non-aqueous solvent is pumped from the recovery tank to the mix tank, where it is combined with appropriate chemicals to create the chemical mixture.

23. A machine as set forth in claim 22, further comprising an additional application apparatus, where the chemical mixture is applied to an additional side of the substrate.

24. A method for applying a chemical solution to a substrate, comprising the acts of:
forming a chemical mixture comprising a non-aqueous solvent and a chemical solute;
applying the chemical mixture with the substrate forming a wet substrate;
and removing the non-aqueous solvent from the wet substrate, leaving a substrate with remaining chemical solution.

25. A method of claim 24, furthering comprising an act of selecting an application apparatus before the act of applying the chemical mixture with the substrate, the application apparatus is selected from a group consisting of a foam applicator, spray applicator, and a padding applicator.

26. A method of claim 24, wherein the act of removing the non-aqueous solvent from the wet substrate comprises the acts of:
removing a portion of the chemical mixture from the wet substrate, leaving a substrate with remaining chemical mixture;
lowering a boiling point of the non-aqueous solvent in the substrate with remaining chemical mixture;
and evaporating the non-aqueous solvent into a solvent vapor.

27. A method of claim 26, further comprising an act of using a squeeze roller as a removal apparatus, before the act of removing a portion of the chemical mixture from the wet substrate.

28. A method of claim 26, further comprising an act of using a heat exchanger as an evaporator apparatus, before the act of evaporating the non-aqueous solvent into a solvent vapor.

29. A method of claim 28, further comprising an act of using a steam-based heat exchanger as the heat exchanger.

30. A method of claim 26, further comprising an act:
of preventing vapors from escaping by creating a negative pressure; and
removing remaining solvent vapors.

31. A method of claim 30, further comprising an act of selecting a blower apparatus before the act of preventing vapors from escaping by creating a negative pressure, the blower apparatus being selected from a group consisting of a fan, and a blower.

32. A method of claim 30, further comprising an act of using a separator comprising a mist eliminator and a high efficiency separator, before the act of removing remaining solvent vapors.

33. A method of claim 30, further comprising an act of collecting any removed non-aqueous solvent.

34. A method of claim 33, wherein the act of collecting any removed non-aqueous solvent comprises acts:
of pushing the solvent vapor into a vapor scrubber chamber via the negative pressure;
condensing the solvent vapor into a condensed liquid solvent solution;
collecting the condensed liquid solvent solution and the portion of the chemical mixture into a collected solution;
heating the collected solution to vaporize the non-aqueous solvent into a re-vaporized non-aqueous solvent;
cooling and condensing the re-vaporized non-aqueous solvent into a re-condensed non-aqueous solvent; and
collecting the re-condensed non-aqueous solvent in a recovery tank.

35. A method of claim 34, further comprising an act of using a water spray mechanism as a condensing apparatus, before the act of condensing the solvent vapor into a condensed liquid solvent solution.

36. A method of claim 34, further comprising an act of using a steam-based heat exchanger as the heating method for the re-boiler tank, before the act of heating the collected solution to vaporize the non-aqueous solvent into a re-vaporized non-aqueous solvent.

37. A method of claim 34, further comprising an act of pumping the re-condensed non-aqueous solvent from the recovery tank to a mix tank, where it may be combined with appropriate chemicals to create the chemical mixture.

38. A method of claim 37, further comprising an act of pumping the chemical mixture to the application apparatus.

39. A method of claim 35, furthering comprising an act of selecting an application apparatus before the act of applying the chemical mixture with the substrate, the application apparatus being selected from a group consisting of a foam applicator, spray applicator, and a padding applicator.

40. A method of claim 39, further comprising an act of using a squeeze roller as a removal apparatus, before the act of removing a portion of the chemical mixture from the wet substrate.

41. A method of claim 40, further comprising an act of using a heat exchanger as an evaporator apparatus, before the act of evaporating the non-aqueous solvent into a solvent vapor.

42. A method of claim 41, further comprising an act of using a steam-based heat exchanger as the heat exchanger.

43. A method of claim 42, further comprising an act of selecting a blower apparatus before the act of preventing vapors from escaping by creating a negative pressure, the blower apparatus being selected from a group consisting of a fan, and a blower.

44. A method of claim 43, further comprising an act of using a separator comprising a mist eliminator and a high efficiency separator, before the act of removing remaining solvent vapors.

45. A method of claim 44, further comprising an act of using a steam-based heat exchanger as a re-boiler tank, before the act of heating the collected solution to vaporize the non-aqueous solvent into a re-vaporized non-aqueous solvent.

46. A method of claim 45, further comprising an act of pumping the re-condensed non-aqueous solvent from the recovery tank to a mix tank, where it may be combined with appropriate chemicals to create the chemical mixture.

47. A method of claim 46, further comprising an act of pumping the chemical mixture to the application apparatus.

48. A method of claim 47, further comprising an act of pumping the chemical mixture to an additional application apparatus, where the chemical mixture is applied to an additional side of the substrate.

49. A machine for applying a chemical solution to a substrate, comprising:
a means for forming a chemical mixture comprising a non-aqueous solvent and a chemical solute;
a means for applying the chemical mixture with the substrate, forming a wet substrate; and
a means for removing the non-aqueous solvent from the wet substrate, leaving substrate with remaining chemical solution.

50. A machine as set forth in claim 49, wherein the means for applying the chemical mixture with the substrate, forming a wet substrate, is selected from a group consisting of a foam applicator, spray applicator, and a padding applicator.

51. A machine as set forth in claim 49, wherein the means for removing the non-aqueous solvent from the wet substrate comprises:
a means for removing a portion of the chemical mixture from the wet substrate, leaving a substrate with remaining chemical mixture;
a means for lowering a boiling point of the non-aqueous solvent in the substrate with remaining chemical mixture; and
a means for evaporating the non-aqueous solvent into a solvent vapor.

52. A machine as set forth in claim 51, wherein the means for removing a portion of the chemical mixture from the wet substrate, is a squeeze roller.

53. A machine as set forth in claim 51, wherein the means for evaporating the non-aqueous solvent into a solvent vapor is a heat exchanger.

54. A machine as set forth in claim 53, wherein the heat exchanger is a steam-based heat exchanger.

55. A machine as set forth in claim 51, further comprising:
a means for preventing vapors from escaping by creating a negative pressure; and
a means for removing remaining solvent vapors.

56. A machine as set forth in claim 55, wherein the means for preventing vapors from escaping by creating a negative pressure, is selected from a group consisting of a fan, and a blower.

57. A machine as set forth in claim 55, wherein the means for removing remaining solvent vapors, is a separator comprising a mist eliminator and a high efficiency separator.

58. A machine as set forth in claim 55, further comprising a means for collecting any removed non-aqueous solvent.

59. A machine as set forth in claim 58, wherein the means for collecting any removed non-aqueous solvent comprises:
a means for pushing the solvent vapor into a vapor scrubber chamber via a negative pressure;
a means for condensing the solvent vapor into a condensed liquid solvent solution;
a means for collecting the condensed liquid solvent solution and the portion of the chemical mixture into a collected solution;
a means for heating the collected solution to vaporize the non-aqueous solvent into a re-vaporized non-aqueous solvent;
a means for cooling and condensing the re-vaporized non-aqueous solvent into a re-condensed non-aqueous solvent; and
a means for collecting the re-condensed non-aqueous solvent.

60. A machine as set forth in claim 59, wherein the means for condensing the solvent vapor into a condensed liquid solvent solution, is a water spray mechanism.

61. A machine as set forth in claim 59, wherein the means for heating the collected solution to vaporize the non-aqueous solvent into a re-vaporized non-aqueous solvent, is a steam-based heat exchanger.

62. A machine as set forth in claim 59, further comprising a means for pumping the re-condensed non-aqueous solvent from a recovery tank to a mix tank, where it may be combined with appropriate chemicals to create the chemical mixture.

63. A machine as set forth in claim 62, further comprising a means for pumping the chemical mixture to the application apparatus.

64. A machine as set forth in claim 60, wherein the means for applying the chemical mixture with the substrate, forming a wet substrate, is at least one item selected from a group consisting of a foam applicator, spray applicator, and a padding applicator.

65. A machine as set forth in claim 64, wherein the means for removing a portion of the chemical mixture from the wet substrate, is a squeeze roller.

66. A machine as set forth in claim 65, wherein the means for evaporating the non-aqueous solvent into a solvent vapor is a heat exchanger.

67. A machine as set forth in claim 66, wherein the heat exchanger is a steam-based heat exchanger.

68. A machine as set forth in claim 67, wherein the means for preventing vapors from escaping by creating a negative pressure, is at least one item selected from a group consisting of a fan, and a blower.

69. A machine as set forth in claim 68, wherein the means for removing remaining solvent vapors, is a separator comprising is a mist eliminator and a high efficiency separator.

70. A machine as set forth in claim 69, wherein the means for heating the collected solution to vaporize the non-aqueous solvent into a re-vaporized non-aqueous solvent, is a steam-based heat exchanger taking the form of a re-boiler tank.

71. A machine as set forth in claim 70, further comprising a means for pumping the re-condensed non-aqueous solvent from the recovery tank to a mix tank, where it may be combined with appropriate chemicals to create the chemical mixture.

72. A machine as set forth in claim 71, further comprising a means for pumping the chemical mixture to the application apparatus.

73. A machine as set forth in claim 72, further comprising a means for pumping the chemical mixture to an additional application apparatus.

74. A machine as set forth in claim 73, further comprising a means for applying the chemical mixture to an additional side of the substrate.
